(19) United States
(12) Patent Application Publication
(10) Pub. No.: US 2014/0042091 A1
(43) Pub. Date: Feb. 13, 2014

(54) Method and System For Processing a Solution by Means of a Two-Stage Membrane Process

(71) Applicant: Hans Graf, Mannheim (DE)

(72) Inventor: Hans Graf, Mannheim (DE)

(73) Assignee: KSB Aktiengeselldchaft, Frankenthal (DE)

(21) Appl. No.: 13/984,000

(22) PCT Filed: Feb. 15, 2012
(86) PCT No.: PCT/EP12/52572

§ 371 Date: Oct. 16, 2013

(30) Foreign Application Priority Data
Feb. 16, 2011 (DE) 10 2011 011 417.3
Feb. 14, 2012 (DE) 10 2012 202 202.3

(51) Int. Cl. C02F 9/00; B01D 61/12; B01D 61/02

(52) U.S. Cl. CPC C02F 9/00; B01D 61/022; B01D 61/12
USPC 210/644; 210/252; 210/258; 210/96.2

(57) ABSTRACT

A method and system for processing a solution is provided. In at least one first membrane unit, a feed flow is separated into a permeate flow and a retentate flow. According to the invention, at least part of the retentate flow is fed to at least one second membrane unit. In the second membrane unit, retentate is located on one side of a membrane. Located on the other side is a solution in which the concentration of dissolved substances of which is lower than that of the retentate. Thus solvent of the solution passes through the membrane and thins the retentate.

The invention relates to a process and a system for processing a solution, wherein, in at least one first membrane unit, a feedstream is separated into a permeate stream and a retentate stream.

A solution is a mixture in which substances, for example salts or particles, are dissolved or finely distributed in a liquid solvent, for example water.

A processing of solutions is necessary for production of numerous products. In systems and processes corresponding to the preamble of the invention, membrane separation processes are used for this purpose. The particular advantage thereof is that they succeed without heating and are therefore usually energetically more favorable than thermal separation processes. Two fractions are produced in the membrane technique, which fractions are designated retentate and permeate. The retentate stream is retained by the membrane in the separation process. The fraction of the liquid which passes through the membrane is designated the permeate.

Separation by means of membrane processes has established itself, in particular, in food technology, biotechnology and pharmacy. Depending on the type of membranes used, the selective removal of individual substances or certain substance mixtures is possible.

Membrane separation processes are differentiated according to the driving force which underlies the separation. In the case of the present invention, these are pressure-driven processes in which water is preferably used as solvent.

A pump feeds the still untreated liquid, which is designated the feedstream, to a first membrane unit. What are termed these membrane units may be built up in a modular manner, and so the system can be adapted stepwise to the scope of a separation problem. The separation proceeds by means of at least one semipermeable membrane. The pump builds up a pressure upstream of the semipermeable membrane. The solvent, and frequently some of the dissolved substances, are forced through the membrane in this case.

The size of the retained substances may be set via the choice of membrane. Depending on the size of the retained molecules, a differentiation is made between microfiltration, ultrafiltration, nanofiltration and reverse osmosis.

The use of the invention for carrying out reverse osmosis, in particular for seawater desalination, proves to be particularly expedient. If the concentrated solution is exposed to a pressure which is above the osmotic pressure, water molecules diffuse through the membrane, while the dissolved salts are retained. Thus, on the one side, the salt solution is concentrated, whereas on the other side, low-salt water is obtained. An equilibrium is established between the applied operating pressure and the osmotic pressure which is established. This process is termed reverse osmosis (RO) and is used for seawater desalination.

In the course of their operating time, the membranes can become plugged with deposits. A periodic change of differing operating phases can be used for cleaning the membranes. Here, during a first operating phase, a high pressure is built up on one side of the membrane, in such a manner that a reverse osmosis proceeds. During a second operating phase, the pressure is reduced in such a manner that osmosis takes place. Deposits which have attached to the surface of the membrane are detached by a reversal of the direction of flow.

Seawater desalination offers a good opportunity to provide drinking water in a sufficient amount inexpensively in regions which are low in freshwater and are accessible to the sea. The retentate produced in this case is usually passed back into the sea. Since the salt concentration of the retentate is markedly above that of natural seawater, this can lead to severe pollution of the ecosystem, in particular in the case of large systems.

DE 44 05 365 A1 describes a process for seawater desalination by the principle of reverse osmosis. Here, a high-pressure water stream is passed to an osmosis system and is separated into pure water at atmospheric pressure and a concentrate which is still at high pressure. In the process, a low-pressure water stream is divided upstream of the pressure elevation into two substreams. The first substream is brought to high pressure. The second substream is passed into a pipe chamber feeder. In the pipe chamber feeder, the second substream is exchanged with the high-pressure water stream of the concentrate.

DE 100 59 536 A1 describes a system for seawater desalination by the principle of reverse osmosis. Here, a high-pressure water stream is passed to a reverse osmosis until and separated into permeate and retentate. The concentrate is utilized for energy recovery. The liquid introduced as low-pressure water stream is divided into two substreams. The first substream is brought to high pressure. The second substream is passed into a pressure exchanger. In the pressure exchanger, exchange of the low-pressure water stream with a high-pressure water stream of the concentrate flowing in from the reverse osmosis unit is carried out. To the reverse osmosis unit there is assigned an osmosis extension stage which is connected to the pressure exchanger via an outlet conduit having a pressure booster.

WO 2010/052651 A1 describes a system which operates according to the principle of reverse osmosis. The system comprises a first separation unit in which two chambers are separated by a semipermeable membrane. A stream of a concentrated liquid and a stream of a diluted liquid leave the first separation unit. The stream of the diluted liquid is fed to a second separation unit. Upstream of the second separation unit, a second stream of a concentrated liquid and a second stream of a diluted liquid are removed. The second stream of the concentrated liquid is reused in the purification system.

WO 96/05908 A1 describes a system for water desalination or softening having a membrane unit which is self-cleaning. In this case the build up of a salt layer on the surface of the membrane is prevented. For this purpose the dynamics of water consumption of a building are utilized in order to flush periodically a recirculation/storage vessel which supplies the membrane of the water treatment unit.

It is the object of the invention to provide an environmentally friendly membrane process and a system having a high degree of efficiency.

This object is achieved according to the invention in that at least some of the retentate stream is fed to at least one second membrane unit in which, on the one side of a membrane, retentate is situated, and on the other side a solution, the concentration of dissolved substances in which is lower than that of the retentate, in such a manner that solvent of the solution passes through the membrane and dilutes the retentate.

In contrast to conventional processes and systems, the concentration of dissolved substances in the retentate is thereby decreased. When employing the process for seawater desalination, the salt concentration of the retentate is thus at least partially adapted again to the salt concentration of the natural seawater. Via the dilution, the introduction of the retentate into the sea has considerably smaller effects on the ecosystem.

The process according to the invention is a continuous process in which, in at least one first membrane unit, a reverse osmosis proceeds, and simultaneously in at least one other membrane unit an osmosis process proceeds.

The expressions “first” and “second” membrane units are used for differentiating the different process steps which proceed in these membrane units. In the “first” membrane unit, a reverse osmosis takes place. In the “second” membrane unit, an osmosis proceeds. It is possible here in each case for only one first and one second membrane unit to be used, or a plurality of first or a plurality of second membrane units. Hereafter, for reasons of easier understanding of the text, in each case one first and one second membrane unit are mentioned.

As feedstream, preferably seawater is fed to the first membrane unit, where desalted water is generated as permeate. The highly concentrated salt water produced in the first membrane unit is fed as retentate to the second membrane unit. On the one side of the second membrane unit is found the retentate. On the other side, as solution, preferably seawater is used. The concentration of dissolved salts in the seawater is lower than in the retentate. In the second membrane unit, on account of the osmotic pressure, water passes through the membrane and dilutes the retentate.

In a particularly favorable variant of the process, the entire retentate stream which is produced in the first membrane unit is fed to the second membrane unit.

In the system according to the invention, this is achieved by corresponding piping between the first and second membrane units.

The process steps of reverse osmosis and osmosis proceed in the process according to the invention in parallel and are carried out simultaneously in differing membrane units. This is a continuous process. The pressure level in the second membrane unit is chosen in such a manner that the solvent passes through the membrane into the retentate stream and dilutes it.

The first and second membrane units can be spatially separated from one another completely or integrated within one apparatus.

The pressure level in the second membrane unit is lower than in the first membrane unit. In a particularly expedient process variant, the differing pressure levels between the first and second membrane units are utilized by means of a device.

Here, particularly the use of a pressure exchanger is suitable which transfers the pressure of the retentate, as is present downstream of the first membrane unit, as far as possible to fresh seawater. As a result, the pressure potential still present in the retentate stream is utilized and contributes to a marked energy saving and thus to an increase in the efficiency. In the pressure exchanger, the retentate stream downstream of the first membrane unit flows at high pressure into a first pressure tube and displaces fresh seawater found there. During this, fresh seawater flows into a second pressure tube. There it displaces the retentate which has already given up its pressure. Then, a switchover takes place in such a manner that the pressure tubes exchange their roles. In this case a continuous pulsation-free operation is ensured without mixing fresh seawater and retentate.

The highly concentrated retentate is an energy store which can be utilized by an osmotic process. Hereinafter, by way of example, two possibilities for utilizing this energy store are described. The storage of the energy-rich concentrated retentate does not require any particular precautions with respect to contamination in respect of the utilization in the second membrane unit.

In a particularly advantageous embodiment, the dilution of the retentate causes an increase in the pressure level in the second membrane unit. This can be implemented, for example, in that the second membrane unit is constructed in such a manner that, owing to the inflow of solvent, the fill level in a container rises and in this manner the hydrostatic pressure increases.

An alternative or supplementary variant for increasing the pressure level on the retentate side of the second membrane unit is that the second membrane unit is constructed in such a manner that, owing to the inflow, the pressure at which the liquid is rises. This can be implemented, for example, in that the retentate completely fills a chamber. If solvent flows through the membrane into the chamber, a great pressure increase occurs, since the retentate cannot escape. The pressure rise is very great even with small overflowing amounts of solvent, since liquids are incompressible. To permit a greater dilution effect of the retentate, gas cushions can be provided in the chamber. If solvent flows into the chamber, the gas cushions then compress. Although, as a result, the pressure level does not increase so rapidly, a greater dilution effect is achieved.

The pressure rise can be at maximum as high as the osmotic pressure. The higher the concentration difference in dissolved salts between the retentate side and the seawater side in the second membrane unit, the greater is the osmotic pressure. In addition, the osmotic pressure depends on the temperature.

In a particularly advantageous embodiment of the invention, the pressure level of the retentate stream downstream of the second membrane unit is utilized by means of an energy recovery unit. Here, the use of a turbine proves to be particularly advantageous. In this manner the efficiency of the process and the system are increased. The mechanical work of the turbine can be utilized for generating electrical power or directly for driving a transport appliance, for example a pump.

The membranes used in the first and second membrane units can plug with fouling with increasing time of operation. Since the flow direction through the membranes is actually reversed in the two membrane units, the membranes can be exchanged for detaching the fouling. In a particularly advantageous embodiment of the invention, the streams can also be switched over in such a manner that, for the purpose of cleaning, osmosis proceeds in the first membrane unit, and reverse osmosis in the second membrane unit.

In a particularly advantageous variant of the process, the solution which is fed to the second membrane unit has the same concentration of dissolved substances as the feedstream which is fed to the first membrane unit. In this case it proves particularly expedient when the solution and the feedstream are taken off from the same reservoir. Important components of the feedstream processing can be utilized jointly as a result.

In a further embodiment, in the system, sensors for measuring the concentrations of matter are provided in the individual sections of the system, wherein the sensors are connected to a superior control system, wherein, in the superior control system, setpoints for the individual sections can be deposited, wherein the superior control system is connected to actuators which are actuable for setting setpoints. As described at the outset, seawater desalination systems have a considerable effect on the local ecosystem. The arrangement according to the invention permits a highly advantageous dilution of the retentate. In combination with a regular observation of the neighboring ecosystem, limiting values may be determined for salt input via the desalination system which can be input into a superior control system.

Further features and advantages of the invention result from the description of an exemplary embodiment with reference to drawings and from the drawings themselves. In the drawings

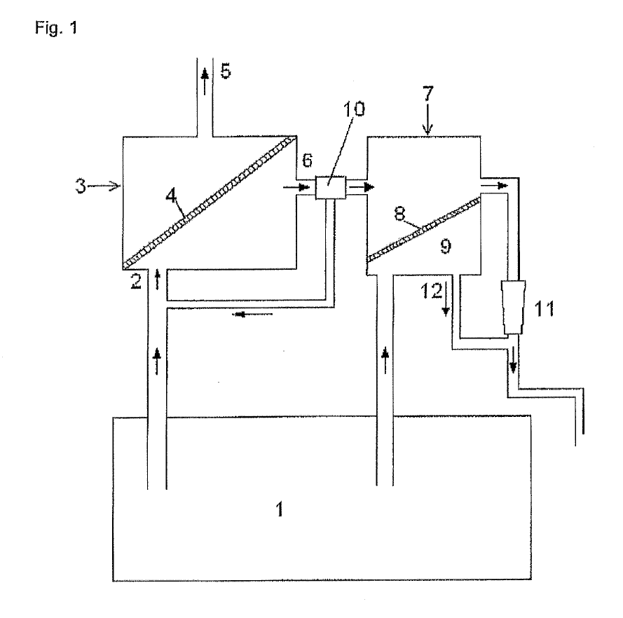

FIG. 1 shows a schematic flow chart of a process for seawater desalination,

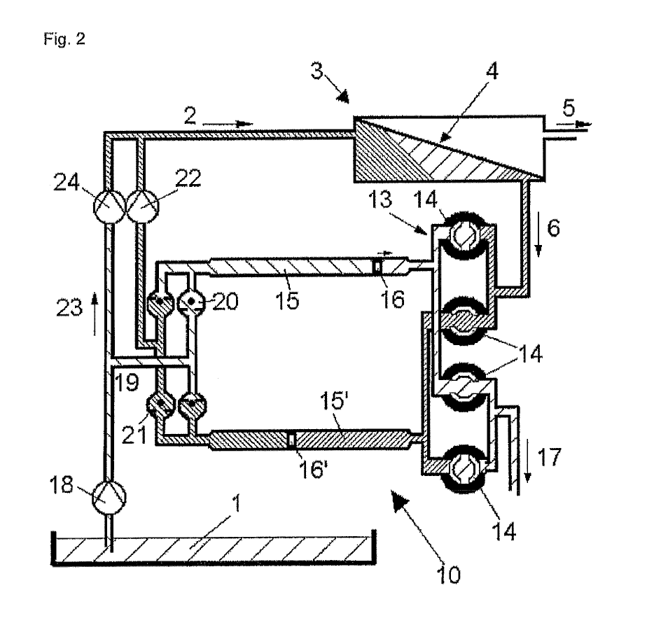

FIG. 2 shows a schematic flow chart of the first part of the process with a more detailed description of the pressure exchanger.

From a reservoir 1, a feedstream 2 of seawater is fed to a first membrane unit 3. The seawater, before its storage in the reservoir 1, or before the feed to the first membrane unit 3, is freed from components which could damage or foul the semipermeable membrane 4.

In the first membrane unit 3, a reverse osmosis takes place in which the seawater is forced under high pressure through the membrane 4. In this process, the osmotic pressure must be overcome. The semipermeable membrane 4 can consist, for example, of polyamide, PTFE or sulfonated copolymers having a pore diameter of 5·10⁻⁷ to 5·10⁻⁶ mm. The membrane 4 allows water through and retains the salts. The first membrane unit 3 separates the feedstream 2 into a permeate stream 5 and a retentate stream 6. The permeate stream 5 is substantially salt-free pure water. The retentate stream 6 has a higher salt concentration than the fed feedstream 2.

At least some of the retentate stream 6 is fed to a second membrane unit 7. In the second membrane unit 7, retentate is situated on the one side of a semipermeable membrane 8, and on the other side, a solution 9, in which the concentration of dissolved substances is lower than that of the retentate. In the exemplary embodiment, for this purpose, seawater is fed from the reservoir 1 to the second membrane unit 7.

The pressure on the retentate side of the second membrane unit 7 is lower than on the retentate side of the first membrane unit 3. By means of a device 10, the pressure difference between the first membrane unit 3 and the second membrane unit 7 is utilized. The device 10 is connected between the first membrane unit 3 and the second membrane unit 7.

In the exemplary embodiment, as device 10, a pressure exchanger is used. The pressure exchanger is shown in FIG. 1 only as a square symbol 10. A detailed explanation proceeds in the context of the description of FIG. 2.

In the second membrane unit 7, an osmosis proceeds. The motive force of the spontaneously proceeding osmosis is the difference between the concentrations of one or more substances of the retentate side and the side having the solution 9 separated by the membrane 8. The solution 9 is fed from the same reservoir 1, from which the feedstream 2 is also taken off. Solvent of the solution 9 passes through the membrane 8. As a result, the retentate is diluted. Salts situated in the solution 9 are retained by the membrane 8. Owing to the overflow of water through the membrane 8, the difference in concentration of dissolved salts is decreased.

Owing to the overflow of solvent, on the retentate side of the second membrane unit 7, a pressure builds up. The pressure is utilized by means of an energy recovery unit 11. In the exemplary embodiment, the energy recovery unit 11 is connected downstream of the second membrane unit 7. A turbine is used as energy recovery unit 11. The retentate diluted with water flows to the turbine. The mechanical work of the turbine can be utilized for generating electrical energy or for pumping. As a result, the efficiency of the process is increased.

Downstream of the energy recovery unit 11, the diluted retentate is passed back into the sea. Here, the diluted retentate stream is combined with a stream 12.

The stream 12 is the solution 9 which, compared with the pure seawater from the reservoir 1, has an elevated salt concentration, since solvent has passed from the solution 9 to the other side of the membrane 8, but the salts were retained.

FIG. 2 shows a flow chart of the first part of the process with a more detailed description of the pressure exchanger. The retentate stream 6, downstream of the first membrane unit 3, flows under high pressure to a switchover unit 13. The switchover unit 13 comprises four rotary-piston slide valves 14 which rotate clockwise with respect to the view onto the drawing.

FIG. 2 is a snapshot, in which the rotary-piston slide valves 14 adopt a position in which, from the upper pressure tube 15, the low-pressure retentate is forced out to the pipe 17 by a separating body 16. The pipe 17 leads to the second membrane unit 7.

At the same time, the upper pressure tube 15 fills with fresh seawater from the reservoir 1. The seawater is taken in by suction by a pump 18. Some of the seawater flows in a branch 19 via a nonreturn valve 20 into the upper pressure tube 15.

Simultaneously with this process, the separating body 16′ forces seawater out of the lower pressure tube 15′. The seawater flows through the nonreturn valve 21 and a pump 22 to the first membrane unit 3. The feedstream 2 is additionally fed by a stream 23 which is fed via a pump 24. Whereas the seawater is displaced from the lower pressure tube 15′, it fills simultaneously with high-pressure retentate from the first membrane unit 3.

Then, the switchover unit 13 switches over, wherein the pressure tubes 15, 15′, exchange their tasks. In this case a continuous, pulsation-free operation without mixing of fresh seawater and retentate is ensured.

1-21. (canceled)

22. A process for processing a solution, comprising the acts of:
separating a feedstream in at least one first membrane unit into a permeate and a retentate;
feeding at least a portion of the retentate into at least one second membrane unit in which the portion of retentate is on a first side of a membrane and on an second side of the membrane is a solution having a concentration of dissolved substances lower than a concentration of dissolved substances in the portion of the retentate; and
diluting the portion of the retentate on the first side of the second membrane unit membrane, wherein the diluting process comprises passing a solvent of the solution having the lower concentration of dissolved substances from the second side of the membrane to the first side of the membrane.

23. The process as claimed in claim 22, wherein a pressure of the retentate in the at least one second membrane unit is lower than a pressure of the retentate in the first membrane unit.

24. The process as claimed in claim 23, wherein a pressure difference between the pressure of the retentate in the at least one first membrane unit and the retentate in the at least one second membrane unit is used to operate a pressure difference-powered device arranged between the at least one first membrane unit and the at least one second membrane unit.

25. The process as claimed in claim 24, wherein the pressure difference-powered device is a pressure exchanger.

26. The process as claimed in claim 24, wherein the pressure difference-powered device is a turbine.

27. The process as claimed in claim 22, wherein the diluting act causes increases the pressure of the retentate in the at least one second membrane unit.

28. The process as claimed in claim 22, wherein a pressure of the retentate downstream of the at least one second membrane unit is utilized by an energy recovery unit.

29. The process as claimed in claim 28, wherein the energy recovery unit is a turbine.

30. The process as claimed in claim 22, wherein the solution on the second side of the at least one second membrane unit has a concentration of dissolved substances equal to a concentration of dissolved substances in the feedstream entering the at least one first membrane unit.

31. The process as claimed in claim 30, wherein the solution and the feedstream are supplied to the at least one second membrane unit and the at least one first membrane unit, respectively, from a common source.

32. The process as claimed in claim 31, further comprising the acts of:
sensing a concentration of dissolved substances in a discharged solution downstream of the at least one second membrane unit and altering amounts of at least one of the retentate and the solution being fed to the at least one second membrane unit to achieve a predetermined setpoint concentration in the discharged solution.

33. A system for processing a solution, comprising:
at least one first membrane configured to separate a feedstream into a permeate and a retentate;
at least one second membrane unit configured to receive at least a portion of the retentate and a solution having a lower dissolved substances concentration than a dissolved substances concentration of the retentate stream on respective first and second sides of a membrane of the at least one second membrane unit, the membrane being configured to permit a solvent of the solution to pass from the second side of the membrane to the first side of the membrane.

34. The system as claimed in claim 23, wherein a pressure of the retentate in the at least one second membrane unit is adjustable to a pressure which is lower than a pressure in the in the retentate in the at least one first membrane unit.

35. The system as claimed in claim 33, wherein a pressure difference between the retentate in the at least one first membrane unit and the at least one second membrane unit is utilizable by a pressure difference-powered device arranged between the at least one first membrane unit and the at least one second membrane unit.

36. The system as claimed in claim 35, wherein the pressure difference-powered device is a pressure exchanger.

37. The system as claimed in claim 33, wherein the at least one second membrane unit is configured to permit an increase in the pressure in the retentate in the at least one second membrane unit when a solvent of the solution having the lower dissolved substances concentration on the second side of the at least one second membrane unit passes into the first side of the at least one second membrane unit.

38. The system as claimed in claim 23, wherein a pressure of the retentate downstream of the at least one second membrane unit is utilizable by an energy recovery unit.

39. The system as claimed in claim 38, wherein the energy recovery unit is a turbine.

40. The system as claimed in claim 23, wherein the solution to be supplied to the second side of the at least one second membrane unit has a dissolved substances concentration as a dissolved substances concentration of as the feedstream to be supplied to the at least one first membrane unit.

41. The system as claimed in claim 40, wherein the solution and the feedstream are suppliable from the same source.

42. The system as claimed in claim 41, further comprising:
at least one sensor for sensing concentrations of dissolved substances in at least a discharged solution downstream of the at least one second membrane unit; and
a superior control system configured to, in response to sensed concentrations sensed by the at least one sensor, alter amounts of at least one of the retentate and the solution being fed to the at least one second membrane unit to achieve a predetermined setpoint concentration in the discharged solution.
